(19) United States
(12) Patent Application Publication
(10) Pub. No.: US 2023/0189004 A1
(43) Pub. Date: Jun. 15, 2023

(54) METHOD OF USING HARDWARE IDENTIFIERS TO DETECT IoT SECURITY INCIDENTS

(71) Applicant: Aeris Communications, Inc., San Jose, CA (US)

(72) Inventors: HyungHo Kim, Cupertino, CA (US); Jins George, Fremont, CA (US); Leif Ronnie Pettersson, San Jose, CA (US); Subramanian Balakrishnan, Cupertino, CA (US); Ravindran Harigopan Nair, Santa Clara, CA (US)

(21) Appl. No.: 18/065,224

(22) Filed: Dec. 13, 2022

Related U.S. Application Data
(60) Provisional application No. 63/289,444, filed on Dec. 14, 2021.

(51) Int. Cl. H04W 12/71; H04W 8/20; H04W 8/18; H04W 12/76; H04L 9/40

(52) U.S. Cl. CPC H04W 12/71; H04W 8/20; H04W 8/186; H04W 12/76; H04L 63/1425

(57) ABSTRACT

A computer-implemented method and system for identifying and managing security incidents for IoT devices operating on a cellular network are disclosed. The method includes receiving device hardware identifier from one or more devices operating on a cellular network; using the received device hardware identifier to retrieve additional device information from the device information storage database; and initiating an action for the one or more devices when the retrieved additional device information does not match expected additional device information, wherein the expected additional device information is based on the received device hardware identifier.

### CROSS-REFERENCE TO RELATED APPLICATIONS

Under 35 USC 119(e), this application claims priority to U.S. provisional application Ser. No. 63/289,444, entitled “METHOD OF USING HARDWARE IDENTIFIERS TO DETECT IoT SECURITY INCIDENTS”, filed on Dec. 14, 2021, all of which is herein incorporated by reference in its entirety.

### FIELD OF THE INVENTION

The embodiments described herein relate generally to cellular/wireless networks and more particularly to identifying and managing security incidents for IoT devices operating on cellular/wireless networks.

### BACKGROUND

In many Internet-of-Things (IoT)/Machine-to-Machine (M2M) solutions, it may be useful to identify security threats and vulnerabilities for the IoT devices operating on cellular/wireless networks and use the collected information for identifying and managing security incidents for IoT devices.

### SUMMARY

In one example embodiment, a computer implemented method for identifying and managing security incidents for IoT devices operating on cellular networks is disclosed. The method includes receiving device hardware identifier from one or more devices operating on a cellular network; using the received device hardware identifier to retrieve additional device information from the device information storage database; and initiating an action for the one or more devices when the retrieved additional device information does not match expected additional device information, wherein the expected additional device information is based on the received device hardware identifier.

In another example embodiment, a system for identifying and managing security incidents for IoT devices operating on cellular networks is disclosed. The system includes a processor and a storage database, wherein the system receives device hardware identifier from one or more devices operating on a cellular network; uses the received device hardware identifier to retrieve additional device information from the device information storage database; and initiates an action for the one or more devices when the retrieved additional device information does not match expected additional device information, wherein the expected additional device information is based on the received device hardware identifier.

In an embodiment, a non-transitory computer-readable medium for identifying and managing security incidents for IoT devices operating on cellular networks is disclosed. The non-transitory computer-readable medium for identifying and managing security incidents for IoT devices operating on a cellular network having executable instructions stored therein that, when executed, cause one or more processors corresponding to a system having a one or more devices operating on a cellular network, a processor and a storage database to perform operations comprising: receiving device hardware identifier from one or more devices operating on a cellular network; using the received device hardware identifier to retrieve additional device information from the device information storage database; and initiating an action for the one or more devices when the retrieved additional device information does not match expected additional device information, wherein the expected additional device information is based on the received device hardware identifier.

In an embodiment, the method further includes automatically blocking the IoT devices that have been identified as security threats.

In an embodiment, the system automatically blocks the IoT devices that have been identified as security threats.

In an embodiment, the non-transitory computer-readable medium further includes instructions for automatically blocking the IoT devices that have been identified as security threats.

### BRIEF DESCRIPTION OF THE DRAWINGS

FIG. 1 is an overview diagram for system 100 and process used for identifying and managing security incidents for IoT devices operating on cellular/wireless networks according to an embodiment described herein.

FIG. 2 illustrates a system and process 200 used for identifying and managing security incidents for IoT devices operating on cellular/wireless networks according to an embodiment described herein.

FIGS. 3A and 3B illustrates a system and process 300 and 300′ used for identifying and managing security incidents for IoT devices operating on cellular/wireless networks according to an embodiment described herein.

FIG. 4 illustrates a data processing system 400 suitable for storing the computer program product and/or executing program code relating to identifying and managing security incidents for IoT devices operating on cellular/wireless networks in accordance with an embodiment described herein.

### DETAILED DESCRIPTION

The embodiments described herein relate generally to cellular/wireless networks and more particularly to managing IoT device lifecycle for IoT devices operating on cellular/wireless networks. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the embodiments described herein are not intended to be limited to the embodiments shown, but is to be accorded the widest scope consistent with the principles and features described herein.

In many Internet-of-Things (IoT)/Machine-to-Machine (M2M) solutions, it may be useful to identify security threats and vulnerabilities for the IoT devices operating on cellular/wireless networks and use the collected information for identifying and managing security incidents for IoT devices.

Organizations managing deployment of large scale IoT devices should have a good understanding of how their IoT devices are operating and their cellular/wireless network data usage. Often it is very complex and time-consuming process to keep track of each device, identify security threats and vulnerabilities for the IoT devices operating on cellular/wireless networks and use the collected information for identifying and managing security incidents for IoT devices. The embodiments described herein involve data retrieval on a large-sized dataset, which is not feasible with a pen and paper or any manual analysis tools.

As part of the IoT operational security solution, identifying security threats and vulnerabilities is very important. In the IoT domain, this can be increasingly challenging due to its rapid proliferation & scale, constrained resources, etc. One or more embodiments described herein utilize device hardware identifier to overcome the above challenges.

The IoT devices usually have unique hardware identifiers assigned to them like IMEI (International Mobile Equipment Identity) which include type allocation code (TAC) as part of the identifier. One or more embodiments described herein utilize this type of identifier for identifying and managing security incidents for IoT devices efficiently. For example, the existence of non-IoT devices such as phones or tablets on IoT networks often indicates unauthorized usage of resources and needs to be identified. The system can identify the non-IoT devices by deriving device types from devices' hardware identifiers such as IMEI. Although the invention is described using IMEI as device hardware identifier, a person skilled in the art may readily recognize that using other identifiers that can identify device type is also within the scope of this invention and is covered by the present disclosure.

Additionally or alternatively, in an embodiment, detecting unauthorized changes to devices, such as swapping SIMs installed in the devices, are utilized to identify security incidents. For example, when a device first registers on a cellular/wireless network and/or updates packet session, it provides its device hardware identifier (also referred to herein as device-ID) or IMEI (International Mobile Equipment Identity) along with subscription-ID or IMSI (International Mobile Subscriber Identity), which is stored in a storage database and is retrieved and matched by the system every time the device uses the cellular/wireless network for data transfer. If the stored device-ID/IMEI doesn't match the existing device-ID/IMEI, the system will alert the user via user interface or initiate or take an action such as blocking the device from accessing the cellular/wireless network.

In an embodiment, the device type identification using TAC may be used in combination with a network-based security management system, which may also be called as Network Intrusion Detection System (NIDS) analyzes the network traffic to detect suspicious behaviors/potentially malicious patterns and identify the compromised devices. In the IoT domain where there are many heterogeneous devices that are conducting only a single or a small number of functions, anomaly detection may be challenging as it may lead to high false positives. By grouping (or classifying) the patterns by device types derived by device hardware identifier (also referred to herein as device-ID) such IMEI and applying separate anomaly detection for the patterns from the homogeneous devices, the performance of the network-based security management system may significantly improve. Although the invention is described using IMEI as device hardware identifier, a person skilled in the art may readily recognize that using other identifiers that can identify device type is also within the scope of this invention and is covered by the present disclosure.

Additionally, the system may further derive or identify functionality of a device based on any one or more of: make, model and manufacturer of the device from devices' hardware identifiers such as IMEI which includes TAC. This may be used by the system to group the devices based on functionality. Although the invention is described using device type, device manufacturer, device functionality, etc. as grouping parameters, a person skilled in the art may readily recognize that using other grouping parameters that can classify the devices similar to that using device type and/or functionality is also within the scope of this invention and is covered by the present disclosure.

Similarly, although the invention is described using IMEI as device hardware identifier, a person skilled in the art may readily recognize that using other identifiers that can identify and further classify the devices similar to that using device type is also within the scope of this invention and is covered by the present disclosure.

Thus, the method and system are provided to automatically identify security threats and vulnerabilities for the IoT devices operating on cellular/wireless networks and use the collected information for identifying and managing security incidents for IoT devices. Additionally, an automated method for initiating an action to block the IoT devices or blocking the IoT devices that have been identified as security threats may also be provided.

In one example embodiment, a computer implemented method for identifying and managing security incidents for IoT devices operating on cellular networks is disclosed. The method includes receiving device hardware identifier from one or more devices operating on a cellular network; using the received device hardware identifier to retrieve additional device information from the device information storage database; and initiating an action for the one or more devices when the retrieved additional device information does not match expected additional device information, wherein the expected additional device information is based on the received device hardware identifier.

In another example embodiment, a system for identifying and managing security incidents for IoT devices operating on cellular networks is disclosed. The system includes a processor and a storage database, wherein the system receives device hardware identifier from one or more devices operating on a cellular network; uses the received device hardware identifier to retrieve additional device information from the device information storage database; and initiates an action for the one or more devices when the retrieved additional device information does not match expected additional device information, wherein the expected additional device information is based on the received device hardware identifier.

In an embodiment, a non-transitory computer-readable medium for identifying and managing security incidents for IoT devices operating on cellular networks is disclosed. The non-transitory computer-readable medium for identifying and managing security incidents for IoT devices operating on a cellular network having executable instructions stored therein that, when executed, cause one or more processors corresponding to a system having a one or more devices operating on a cellular network, a processor, and a storage database to perform operations comprising: receiving device hardware identifier from one or more devices operating on a cellular network; using the received device hardware identifier to retrieve additional device information from the device information storage database; and initiating an action for the one or more devices when the retrieved additional device information does not match expected additional device information, wherein the expected additional device information is based on the received device hardware identifier.

In an embodiment, the method further includes automatically blocking the IoT devices that have been identified as security threats.

In an embodiment, the system automatically blocks the IoT devices that have been identified as security threats.

In an embodiment, the non-transitory computer-readable medium further includes instructions for automatically blocking the IoT devices that have been identified as security threats.

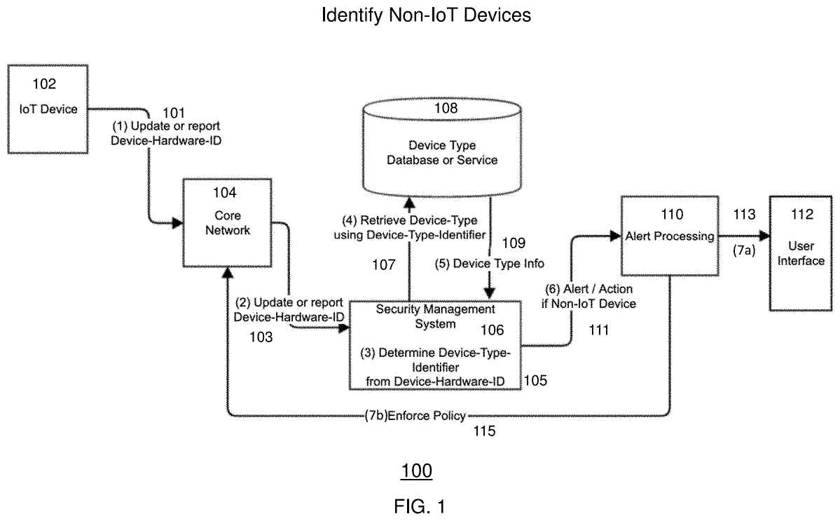

FIG. 1 is an overview diagram for system 100 and process used for identifying and managing security incidents for IoT devices operating on cellular/wireless networks according to an embodiment described herein. For example, IoT device 102 has a unique hardware identifier assigned to it like International Mobile Equipment Identity (IMEI) which includes type allocation code (TAC) as part of the identifier. For example, for Global System for Mobile Communications (GSM) and long-term evolution (LTE), the device identifier (IMEI) format may be AA-BBBBBB-CCCCCC, where AA-BBBBBB is Type Allocation Code (TAC), wherein AA is a Reporting Body Identifier and BBBBBB is remainder of TAC; and CCCCCC is a serial number. The reporting body as used herein refers to the GSMA-approved organization that registered (or, before 2002, approved) a given mobile device, and allocated the model a unique code. When the device 102 first registers on a cellular/wireless network and/or updates packet session, it provides its device-ID (device hardware identifier), for example, International Mobile Equipment Identity (IMEI) to the core network 104 via step 101, which is collected by the security management system 106.

The security management system 106 determines device type identifier from the device hardware identifier (ID) via step 105. The security management system 106 retrieves device type from the device type database or service stored in a storage database 108 via steps 107 and 109 using the device type identifier. This device type information is then matched by the security management system 106 every time the device 102 uses the cellular/wireless network for data transfer. If the device type identifier provided by the device every time the device 102 uses the cellular/wireless network for data transfer does not match the retrieved device type, for example, if the system determines that the device trying to access the cellular/wireless service is a non-IoT device via step 111, it will process alert via alert processing engine 110.

For example, the existence of non-IoT devices such as phones or tablets on IoT networks often indicates unauthorized usage of resources and needs to be identified. The system can identify the non-IoT devices by deriving device types from devices' hardware identifiers such IMEI.

The alert processing engine 110 may be provided with policies for consideration during such scenarios, which may include alerting/notifying the user via user interface 112 via step 113 or take an action such as blocking the device 102 from accessing the cellular/wireless network by enforcing the policies via step 115.

Although the invention is described using IMEI as device hardware identifier, a person skilled in the art may readily recognize that using other identifiers that can identify device hardware type is also within the scope of this invention and is covered by the present disclosure.

Thus, in an embodiment, the method includes receiving device hardware identifier from one or more devices operating on a cellular network; using the received device hardware identifier to retrieve additional device information from the device information storage database; and initiating an action for the one or more devices when the retrieved additional device information does not match expected additional device information, wherein the expected additional device information is based on the received device hardware identifier. In an embodiment, the method further includes analyzing the received device hardware identifier for the one or more devices operating on a cellular network to determine device information features; and using the determined device information features to retrieve additional device information from the device information storage database, wherein the device information features include device type identifier, and the additional device information from the device information storage database for the one or more devices operating on a cellular network includes any of: device type, for example, an IoT device.

In an embodiment, the method further includes automatically blocking the IoT devices that have been identified as security threats.

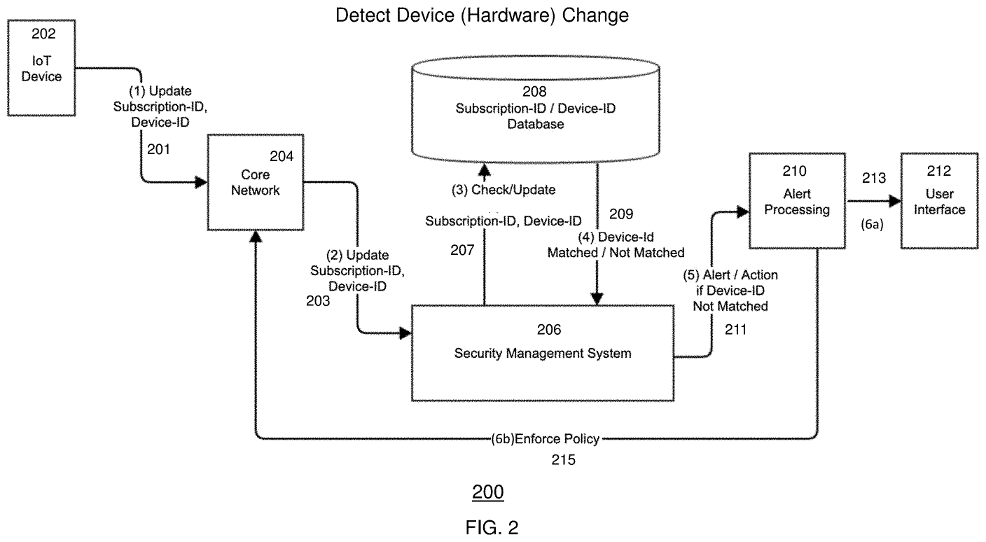

FIG. 2 illustrates a system and process 200 used for identifying and managing security incidents for IoT devices operating on cellular/wireless networks according to an embodiment described herein. For example, when device 202 first registers on a cellular/wireless network and/or updates packet session, it provides its device hardware identifier, (also referred to as device-ID in FIG. 2), for example, International Mobile Equipment Identity (IMEI) along with subscription-ID, for example, International Mobile Subscriber Identity (IMSI) to the core network 204 via step 201, which is collected by the security management system 206 via step 203. This information is stored in a storage database 208 as device hardware identifier (device ID)-subscription ID via step 207 and is retrieved and matched by the system via step 209 every time the device 202 uses the cellular/wireless network for data transfer. If the stored device ID-subscription ID doesn't match the device ID-subscription ID for the device 202 every time the device 202 uses the cellular/wireless network for data transfer, the security management system 206 will process an alert via alert processing engine 210. Thus, in an embodiment, detecting unauthorized changes to devices, such as swapping SIMs installed in the devices, are utilized to identify security incidents.

The alert processing engine may be provided with policies for consideration during such scenarios, which may include alerting/notifying the user via user interface 212 via step 213 or initiate or take an action such as blocking the device 202 from accessing the cellular/wireless network by enforcing the policies via step 215.

Thus, in an embodiment, the method includes receiving device hardware identifier from one or more devices operating on a cellular network; using the received device hardware identifier to retrieve additional device information from the device information storage database; and initiating an action for the one or more devices when the retrieved additional device information does not match expected additional device information, wherein the expected additional device information is based on the received device hardware identifier, wherein the additional device information from the device information storage database for the one or more devices operating on a cellular network includes subscription identifier, for example, International Mobile Subscriber Identity (IMSI) associated with that device-ID (device hardware identifier).

In an embodiment, the method further includes automatically blocking the IoT devices that have been identified as security threats.

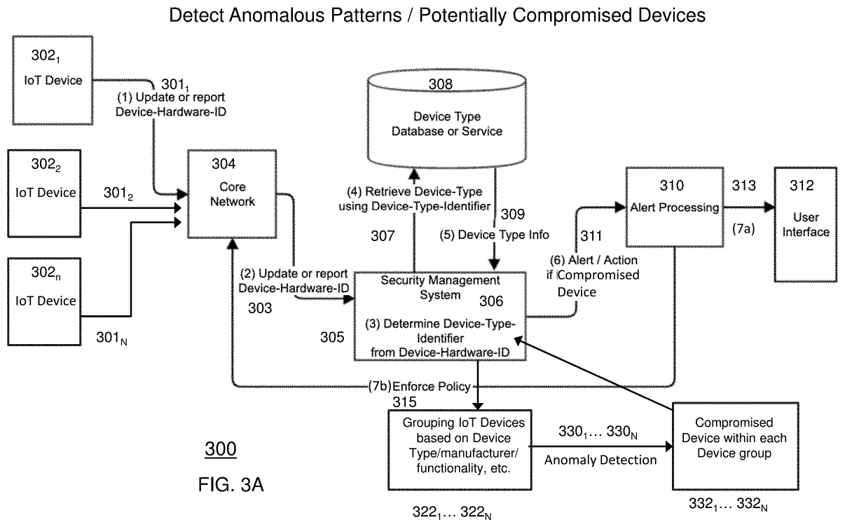

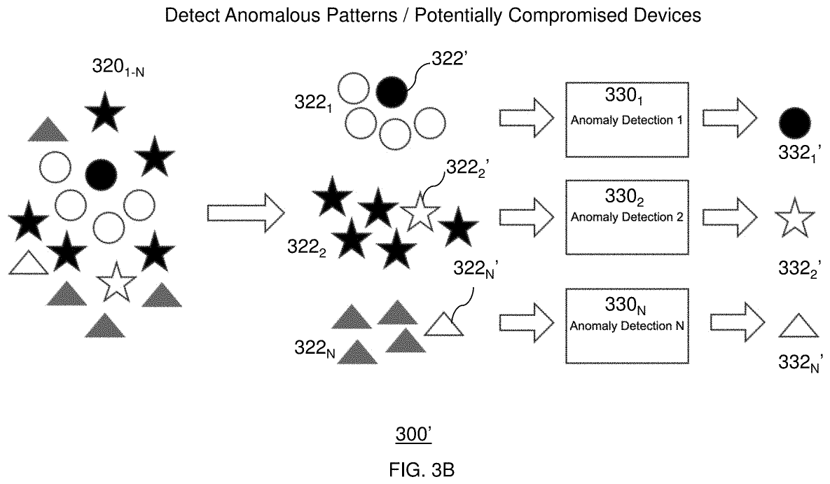

FIGS. 3A and 3B illustrate a system and process 300 and 300′ used for identifying and managing security incidents for IoT devices operating on cellular/wireless networks according to an embodiment described herein. For example, in an embodiment, the device type identification using TAC may be used in combination with a network-based security management system, which may also be referred to as Network Intrusion Detection System (NIDS), analyzes the network traffic to detect suspicious behaviors/potentially malicious patterns and identify the compromised devices.

In the IoT domain where there are many heterogeneous devices that are conducting only a single or a small number of functions, anomaly detection may be challenging as it may lead to high false positives. By grouping (or classifying) the patterns by device types or other grouping parameters such as but not limited to device manufacturer, device functionality, etc., derived from device hardware identifier (also referred to herein as device-ID) such as International Mobile Equipment Identity (IMEI) and applying separate anomaly detection for the patterns from the homogeneous devices, also referred to herein as a group of devices, the performance of the network-based security management system may significantly improve. Although the invention is described using IMEI as device hardware identifier, a person skilled in the art may readily recognize that using other identifiers that can identify device type and/or other grouping parameters is also within the scope of this invention and is covered by the present disclosure.

To perform anomaly detection efficiently for a group of devices which are grouped based on the type of devices, the embodiment described herein uses unique hardware identifier assigned to the one or more devices 302₁ . . . 302ₙ, like International Mobile Equipment Identity (IMEI) which include type allocation code (TAC) as part of the identifier as illustrated in FIG. 3A. For example, IoT devices 302₁ . . . 302ₙ, have unique hardware identifiers assigned to them like International Mobile Equipment Identity (IMEI) which include type allocation code (TAC) as part of the device identifier. When the devices 302₁ . . . 302ₙ, first register on a cellular/wireless network and/or updates packet session, they provide their device hardware identifiers (Device-IDs) or International Mobile Equipment Identity (IMEI) to the core network 304 via steps 301₁ . . . 301ₙ, which are collected by the security management system 306.

The security management system 306 determines device type identifier from each device hardware identifier (device-ID) via step 305. The security management system 306 retrieves device type from the device type database or service stored in a storage database 308 via steps 307 and 309 using those device type identifiers. This device type information is then used by the security management system 306 to group the devices based on device type. The device type may include IoT device, tablet, handheld phone, etc. and each of the device type may be further classified based on make, model, year, functionality of the device, etc.

For example, for Global System for Mobile Communications (GSM) and long-term evolution (LTE), the device identifier (IMEI) format may be AA-BBBBBB-CCCCCC, where AA-BBBBBB is Type Allocation Code (TAC), wherein AA is a reporting body Identifier and BBBBBB is remainder of TAC; and CCCCCC is a serial number. The reporting body as used herein refers to the GSMA-approved organization that registered (or, before 2002, approved) a given mobile device, and allocated the model a unique code. This TAC may be used identify device type as well as to deduce device information or grouping parameters, such as but not limited to, manufacturer of the device and hence functionality of the device which may be deduced from the manufacturer information.

Thus, in an embodiment, the devices may be further grouped based on the make, model, year, functionality, etc. which may then be used for anomaly detection as described herein. This may be used by the system to further group the devices based on device manufacturer, device functionality, etc. Although the invention is described using device type, device manufacturer, device functionality, etc. as grouping parameters, a person skilled in the art may readily recognize that using other grouping parameters that can classify the devices similar to that using device type, device manufacturer, device functionality, etc. is also within the scope of this invention and is covered by the present disclosure.

Similarly, although the invention is described using IMEI as device hardware identifier, a person skilled in the art may readily recognize that using other identifiers that can identify and further classify the devices similar to that using device type is also within the scope of this invention and is covered by the present disclosure.

FIG. 3B illustrates this grouping of the devices based on grouping parameters including any one or more of: device type, device manufacturer, device functionality, and anomaly detection within the grouped devices in detail. For example, in an IoT domain with many heterogeneous devices 320_{1-N} may be grouped (or classified) by any one or more of: device types, device manufacturer, device functionality, derived by device-hardware ID as illustrated in FIG. 3A. An anomaly detection algorithm is applied to the network traffic by the classified or grouped or homogeneous devices via steps 330_{1-N}.

Once the compromised devices are detected by the security management system 306 using anomaly detection in network traffic pattern, as illustrated in FIG. 3B, the security management system 206 will process alert via alert processing engine 210 as illustrated in FIG. 3A. Thus, in an embodiment, grouping (or classifying) the patterns by device types derived by device-ID and applying separate anomaly detection for the patterns from the homogeneous devices is utilized to detect suspicious behaviors/potentially malicious patterns and identify the compromised devices. The alert processing engine 310 may be provided with policies for consideration during such scenarios, which may include alerting/notifying the user via user interface 312 via step 313 or initiate or take an action such as blocking the compromised device from devices 302_{1-N} from accessing the cellular/wireless network by enforcing the policies via step 315.

Although the invention is described using IMEI as device hardware identifier, a person skilled in the art may readily recognize that using other identifiers for example, IMSI, MSISDN, etc. that can identify device hardware type is also within the scope of this invention and is covered by the present disclosure.

Thus, in an embodiment, the method includes receiving device identifier from one or more devices operating on a cellular network; using the received device identifier to retrieve additional device information from the device information storage database; and initiating an action for the one or more devices when the retrieved additional device information does not match expected additional device information, wherein the expected additional device information is based on the received device identifier. In an embodiment, the method further includes analyzing the received device identifier for the one or more devices operating on a cellular network to determine device information features; and using the determined device information features to retrieve additional device information from the device information storage database, wherein the device identifier includes a device hardware identifier, the device information features include device type identifier, and the additional device information retrieved from the device information storage database for the one or more devices operating on a cellular network includes device type, for example, an IoT device, tablet, handheld phone, etc. and each of the device type may be further classified based on make, model, year, functionality of the device, etc. The method further includes grouping the one or more devices based on device type retrieved by using device type identifier; and identifying one or more compromised devices using anomaly detection algorithm to analyze network traffic for each device of the group of devices using network traffic pattern for that type of device.

In an embodiment, the method further includes automatically blocking the IoT devices that have been identified as security threats.

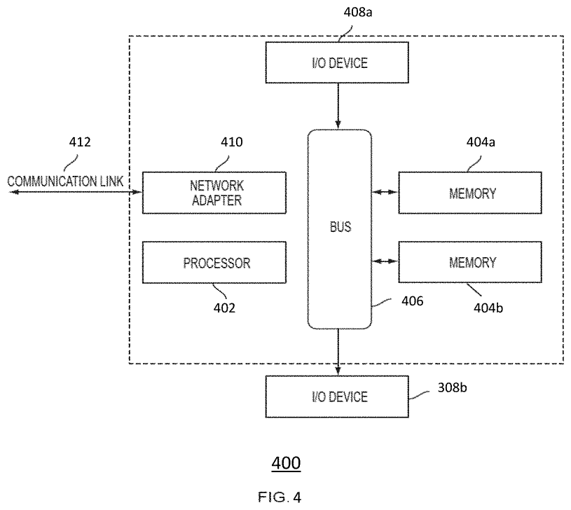

FIG. 4 illustrates a data processing system 400 suitable for storing the computer program product and/or executing program code in accordance with an embodiment of the present invention. The data processing system 400 includes a processor 402 coupled to memory elements 404a-b through a system bus 406. In other embodiments, the data processing system 400 may include more than one processor and each processor may be coupled directly or indirectly to one or more memory elements through a system bus.

Memory elements 404a-b can include local memory employed during actual execution of the program code, bulk storage, and cache memories that provide temporary storage of at least some program code in order to reduce the number of times the code must be retrieved from bulk storage during execution. As shown, input/output or I/O devices 408a-b (including, but not limited to, keyboards, displays, pointing devices, etc.) are coupled to the data processing system 400. I/O devices 408a-b may be coupled to the data processing system 400 directly or indirectly through intervening I/O controllers (not shown).

In FIG. 4, a network adapter 410 is coupled to the data processing system 402 to enable data processing system 402 to become coupled to other data processing systems or remote printers or storage devices through communication link 412. Communication link 412 can be a private or public network. Modems, cable modems, and Ethernet cards are just a few of the currently available types of network adapters.

Embodiments of the process described herein can take the form of an entirely software implementation, or an implementation containing both hardware and software elements. Embodiments may be implemented in software, which includes, but is not limited to, application software, firmware, resident software, microcode, etc.

The steps described herein may be implemented using any suitable controller or processor, and software application, which may be stored on any suitable storage location or computer-readable medium. The software application provides instructions that enable the processor to cause the receiver to perform the functions described herein.

Furthermore, embodiments may take the form of a computer program product accessible from a computer-usable or computer-readable medium providing program code for use by or in connection with a computer or any instruction execution system. For the purposes of this description, a computer-usable or computer-readable medium can be any apparatus that can contain, store, communicate, propagate, or transport the program for use by or in connection with the instruction execution system, apparatus, or device.

The medium may be an electronic, magnetic, optical, electromagnetic, infrared, semiconductor system (or apparatus or device), or a propagation medium. Examples of a computer-readable medium include a semiconductor or solid state memory, magnetic tape, a removable computer diskette, a random access memory (RAM), a read-only memory (ROM), a rigid magnetic disk, and an optical disk. Current examples of optical disks include DVD, compact disk-read-only memory (CD-ROM), and compact disk-read/write (CD-R/W).

Any theory, mechanism of operation, proof, or finding stated herein is meant to further enhance understanding of the present invention and is not intended to make the present invention in any way dependent upon such theory, mechanism of operation, proof, or finding. It should be understood that while the use of the words “preferable”, “preferably” or “preferred” in the description above indicates that the feature so described may be more desirable, it nonetheless may not be necessary and embodiments lacking the same may be contemplated as within the scope of the invention, that scope being defined by the claims that follow. In addition, it should be understood that while the use of words indicating a sequence of events such as “first” and “then” shows that some actions may happen before or after other actions, embodiments that perform actions in a different or additional sequence should be contemplated as within the scope of the invention as defined by the claims that follow.

As used herein, the term “communication” is understood to include various methods of connecting any type of computing or communications devices, servers, clusters of servers, using cellular, wired and/or wireless communications networks to enable processing and storage of signals and information, and where these services may be accessed by applications available through a number of different hardware and software systems, such as but not limited to a web browser terminal, mobile application (i.e., app) or similar, and regardless of whether the primary software and data is located on the communicating device or are stored on servers or locations apart from the devices.

As used herein the terms “device”, “appliance”, “terminal”, “remote device”, “wireless asset”, etc. are intended to be inclusive, interchangeable, and/or synonymous with one another and other similar communication-based equipment for purposes of the present invention, even though one will recognize that functionally each may have unique characteristics, functions and/or operations which may be specific to its individual capabilities and/or deployment.

Similarly, it is envisioned by the present invention that the term “cellular network” includes networks using one or more communication architectures or methods, including but not limited to: Code division multiple access (CDMA), Global System for Mobile Communications (GSM) (“GSM” is a trademark of the GSM Association), Universal Mobile Telecommunications System (UMTS), Long Term Evolution (LTE), 4G LTE, 5G, wireless local area network (WIFI).

Although the present invention has been described in accordance with the embodiments shown, one of ordinary skill in the art will readily recognize that there could be variations to the embodiments and those variations would be within the spirit and scope of the present invention. Accordingly, many modifications may be made by one of ordinary skill in the art without departing from the spirit and scope of the present invention.

What is claimed is:

1. A computer implemented method for identifying and managing security incidents for IoT devices operating on a cellular network, the method comprising:
receiving device hardware identifier from one or more devices operating on a cellular network;
using the received device hardware identifier to retrieve additional device information from the device information storage database; and
initiating an action for the one or more devices when the retrieved additional device information does not match expected additional device information, wherein the expected additional device information is based on the received device hardware identifier.

2. The computer implemented method of claim 1, further comprising:
analyzing the received device hardware identifier for the one or more devices operating on a cellular network to determine device information features; and
using the determined device information features to retrieve additional device information from the device information storage database.

3. The computer implemented method of claim 2, wherein the device information features include device type identifier.

4. The computer implemented method of claim 1, wherein the additional device information from the device information storage database for the one or more devices operating on a cellular network includes any of: device type, device manufacturer, device functionality, subscription identifier for that device, or a combination thereof.

5. The computer implemented method of claim 1, wherein the expected device type includes any one of: an IoT device, a tablet or a phone.

6. The computer implemented method of claim 1, wherein initiating an action for the one or more devices includes sending alerts to the user interface of an entity managing the one or more devices or blocking the one or more devices from using the cellular network.

7. The computer implemented method of claim 4, further comprising:
grouping the one or more devices based on any one more of grouping parameters comprising: device type, device manufacturer, device functionality, retrieved by using device type identifier; and
identifying one or more compromised devices using anomaly detection algorithm to analyze network traffic for each device of the group of devices using network traffic pattern for that group of one or more devices.

8. A system for identifying and managing security incidents for IoT devices operating on a cellular network, the system including a processor and a storage database, wherein the system
receives device hardware identifier from one or more devices operating on a cellular network;
uses the received device hardware identifier to retrieve additional device information from the device information storage database; and
initiates an action for the one or more devices when the retrieved additional device information does not match expected additional device information, wherein the expected additional device information is based on the received device hardware identifier.

9. The system of claim 8, wherein the system further
analyzes the received device hardware identifier for the one or more devices operating on a cellular network to determine device information features; and
uses the determined device information features to retrieve additional device information from the device information storage database.

10. The system of claim 9, wherein the device information features include device type identifier.

11. The system of claim 8, wherein the additional device information from the device information storage database for the one or more devices operating on a cellular network includes any of: device type, device manufacturer, device functionality, subscription identifier for that device, or a combination thereof.

12. The system of claim 8, wherein the expected device type includes any one of: an IoT device, a tablet or a phone.

13. The system of claim 8, wherein the initiated action for the one or more devices includes sending alerts to the user interface of an entity managing the one or more devices or blocking the one or more devices from using the cellular network.

14. The system of claim 11, further comprising:
grouping the one or more devices based on any one more of grouping parameters comprising: device type, device manufacturer, device functionality, retrieved by using device type identifier; and
identifying one or more compromised devices using anomaly detection algorithm to analyze network traffic for each device of the group of devices using network traffic pattern for that group of one or more devices.

15. A non-transitory computer-readable medium for identifying and managing security incidents for one or more IoT devices operating on a cellular network having executable instructions stored therein that, when executed, cause one or more processors corresponding to a system having a one or more devices operating on a cellular network, a processor, and a storage database to perform operations comprising:
receiving device hardware identifier from one or more devices operating on a cellular network;
using the received device hardware identifier to retrieve additional device information from the device information storage database; and
initiating an action for the one or more devices when the retrieved additional device information does not match expected additional device information, wherein the expected additional device information is based on the received device hardware identifier.

16. The non-transitory computer-readable medium of claim 15, further comprising:
analyzing the received device hardware identifier for the one or more devices operating on a cellular network to determine device information features; and
using the determined device information features to retrieve additional device information from the device information storage database.

17. The non-transitory computer-readable medium of claim 16, wherein the device information features include device type identifier.

18. The non-transitory computer-readable medium of claim 15, wherein the additional device information from the device information storage database for the one or more devices operating on a cellular network includes any of: device type, device manufacturer, device functionality, subscription identifier for that device, or a combination thereof.

19. The non-transitory computer-readable medium of claim 15, wherein the expected device type includes any one of: an IoT device, a tablet or a phone.

20. The non-transitory computer-readable medium of claim 15, wherein initiating an action for the one or more devices includes sending alerts to the user interface of an entity managing the one or more devices or blocking the one or more devices from using the cellular network.

21. The non-transitory computer-readable medium of claim 18, further comprising instructions for:
grouping the one or more devices based on any one more of grouping parameters comprising: device type, device manufacturer, device functionality, retrieved by using device type identifier; and
identifying one or more compromised devices using anomaly detection algorithm to analyze network traffic for each device of the group of devices using network traffic pattern for that group of one or more devices.
